(19) United States
(12) Patent Application Publication
(10) Pub. No.: US 2007/0112908 A1
(43) Pub. Date: May 17, 2007

(54) Determination of passages and formation of indexes based on paragraphs

(76) Inventor: Jiandong Bi, Harbin (CN)

Correspondence Address: Jiandong Bi;P.O. Box 1-6, Room 303, Entrance 1, Hongxing Building, 48 Fuhua 4th Street, Nangang District, Harbin, Heilongjiang, 150001, CN

(21) Appl. No.: 11/580,346

(22) Filed: Oct. 16, 2006

Related U.S. Application Data
(60) Provisional application No. 60/728,372, filed on Oct. 20, 2005.

(51) Int. Cl. G06F 15/16

(52) U.S. Cl. 709/200

(57) ABSTRACT

The present invention mainly relates to a method determining passages and forming index. An application of this method is information retrieval. The method of the present invention is to form passages by merging each N consecutive paragraphs, Wherein N is a number greater than 1. Among the passages formed by the method, adjacent passages have N−1 paragraphs to overlap. The rules that people write articles are to express a topic or thought in a paragraph. But people generally can not delimit paragraph precisely. Several paragraphs (for example N paragraphs) are supposed to include a whole thought (or topic). The method of the present invention is that each N consecutive paragraphs in a document forms a passage. If N paragraphs include a topic (or thought), then each topic (or thought) included in the document should have passage that contains it. This is a method making use of people's writing rules to form passages. This method improves the retrieval precision.

### CROSS-REFERENCE TO RELATED APPLICATIONS

The present application claims the benefit of PPA Ser. No. 60/728,372, filed Oct. 20, 2005 by Jiandong Bi

### BACKGROUND OF THE INVENTION

The present invention relates generally to the field of natural language processing, and more particularly to the field of information retrieval. Currently there are great amounts of electronic documents existing, which still increase continually. How to search information from these documents in a precise manner turns into a crucial issue. The process of information retrieval generally gets started with typing a query, and then the retrieval system searches information relevant to the query in a document library (or document set), and returns the results to user.

A typical method of information retrieval is to compare document and query, the document containing more terms included in the query is deemed to have a higher relevance to query. Conversely the document containing less number of terms included in the query is deemed to be less relevant to said query. Documents with high relevance are retrieved. Retrieval methods by comparing terms of an entire document with a query to evaluate relevance are generally referred to as document-based retrieval methodology. A document, in particular, a long document, may contain several dissimilar subjects. On this account the comparative result may not precisely reflect the relevance. It may be the case that long documents contain a greater number of terms, i.e., the document has a higher possibility to contain terms included in the query. In such a case irrelevant documents appear as relevant. Another possible case is that there exists one subject relevant to query in the document. However, the document still contains other subjects, and the proportion of terms identical to the query in said document to the total terms of the whole document is not high (Proportion-based evaluation of relevance is a typical method), accordingly the relevance of the document to query is low.

A passage is a partial document. Passage retrieval is to estimate the relevance of a document (or passage) to query based on the comparison of a partial document with query. Passage retrieval considers only partial document. In addition to the defects of document-based retrieval, accordingly passage retrieval is likely to be more precise than document-based retrieval. For example, if a document containing 3 subjects is divided into 3 passages, and if each contains one subject, passage retrieval should be more precise than document-based retrieval. The bottleneck problem for passage retrieval is how to divide a document into passages.

One method is to form passage by the paragraph of the document. James P. Cllan uses bounded-paragraph as a passage, which is actually pseudo-paragraph of 50 to 200 words in length, formed in such a way to merge short paragraphs and fragment long paragraphs. For details refer to James P. Cllan,” Passage-Level Evidence in Document Retrieval”, Proceedings of the Seventeenth Annual International ACM-SIGIR Conference on Research and Development in Information Retrieval (SIGIR 93) Springer-Verlag, 1994, pp. 302-310.

J. Zobel et al. presents a type of passage, which is referred to as a page. A page is formed by repeatedly merging a paragraph until the bytes of document block resulting from said merge is greater than a certain number. Refer to J. Zobel, et al.,” Efficient retrieval of partial documents”, Information Processing and Management, 31(3):361-377, 1995; This paper authored by Zobel defines that a page shall be merged to at least 1,000 bytes.

Windows-based passages divide a document into segments with an identical number of words. Each segment is a passage. Referring to James P. Cllan, “Passage-Level Evidence in Document Retrieval”, Proceedings of the Seventeenth Annual International ACM-SIGIR Conference on Research and Development in Information Retrieval (SIGIR 93) Springer-Verlag, 1994, pp. 302-310; In this paper, Callan recommends to use 200- or 250-word passages, i.e., a segment with a length of 200 or 250 words is taken as a passage, and half of the length between adjacent passages is overlapped.

These methods referred to above all divide a document into passages of identical length or approximately identical length. But the degree of “sparseness and denseness” of each document is different, namely, when expressing a thought or topic, some persons may use more words, and the document segment formed corresponding to the thought or topic is long. Some persons may be used to a terse expression manner, while expressing the same thought or topic, they use fewer words, and the document segment formed corresponding to the thought or topic is short. So dividing all documents into passages by a single length shall be not to be very reasonable.

### SUMMARY OF THE INVENTION

The present invention mainly relates to a new method forming passages. The method considers the degree of sparseness and denseness of a document. The method is: each N consecutive paragraphs of a document form a passage, wherein N is a number greater than 1. Among the passages formed by the method, adjacent passages (the passages that beginning positions is the nearest) have overlap. They have N−1 paragraphs to be identical. This corresponds to existing a window that moves over a document. The window contains N paragraphs. Each time, the window moves down a paragraph, and each time, the window forms a passage. If a document contains less than N paragraphs, then the document is not partitioned. The whole document is a passage.

At just starting to learn to write articles, people are taught to express a single thought or topic in a paragraph and begin a new paragraph after a topic or thought is expressed. If a person likes a terse expression manner, he perhaps expresses a thought or topic using fewer words. Therefore the paragraph formed may be short. A person who isn't terse may use more words to express a thought. So the paragraph formed may be long. A paragraph reflects the degree of “sparseness and denseness” of an article. Though people are taught to express a thought or discuss a topic in one paragraph, people can't carry out this rule precisely, namely people can't delimit paragraphs precisely (substantially most circumstances is such). While expressing a thought in a paragraph, people may “leak” the thought outside the paragraph, namely leak a thought to the next paragraph, even again next paragraph. If the scope of “leak” does not exceed N paragraphs, namely, if everybody (or the majority of people) use no more than N paragraphs to express a thought or discuss a topic, then it should be a good method to form a passage by uniting N consecutive paragraphs, for in passage retrieval, the objective forming a passage is to make the passage (just) contain a topic. Certainly a topic or thought maybe doesn't exactly correspond to N paragraphs. It perhaps corresponds to 1 paragraph, 2 paragraphs, . . . , N−1 paragraphs or N paragraphs among N paragraphs. But N paragraphs are shorter than the whole document (in the case where the document contains more than N paragraphs), so retrieving based on N paragraphs may get a higher precision than on a whole document. Again, each N consecutive paragraphs forms a passage, so each topic contained in the document have a passages corresponding to it, namely, if a document contains a certain subject, then there must be a passage to contain it. Just as previously described, the method forming passages in the present invention corresponds to existing a window that moves over a document, the window contains N paragraphs, if the expression of each topic does not exceed N paragraphs, and the window moves down a paragraph each time, then the window should be able to “move” through all topics that the document includes, namely each topic in the document has corresponding passage that includes it. As the window boundary is at a boundary of a paragraph (at the beginning or end of a paragraph), the circumstance doesn't exist that a topic is partitioned. If a window boundary is inside a paragraph (not at the beginning or end of a paragraph), then a topic may be partitioned according to the above-mentioned reason (generally people express a topic in a paragraph). This can't guarantee that all topics in a document have corresponding passages. In the present invention, although the number of paragraphs included in a passage is fixed, the passage length isn't fixed. If a document is written in a verbose style, then the document is “sparse”, the words is more which are used to express a topic, then corresponding paragraph may be longer and passage is also longer. If a document is written in a terse style, then the document may be “dense”, the words is fewer which are used to express a topic, then corresponding paragraph may be shorter and passage is also shorter.

Certainly, perhaps such N doesn't exist that makes the expressions of all topics not to exceed N paragraphs. But if the expressions of the majority (even great majority) of topics do not exceed N paragraphs, then such a method forming passages still can show high precision (on the statistics). This has been confirmed in the test for the system implementing the present invention. Namely, such N exists that make retrieval get high precision. In the present, there is no method that can ensure that a passage formed exactly corresponds to a topic. In the present invention, the preferred value of N is 5.

In the implementation of the present invention, an information retrieval system is developed. This information retrieval system comprises an index generation phase, and a document search phase in which relevant documents are searched based on the query. An index is an indication of the relationship between documents and words. Most generally, an index shows occurrence times and position of words in documents. In the present invention, an index is a set of Document Number-Word Number pairs. Each pair is referred to as an index term. Document Numbers represents a specific document, Word Numbers represents the number of times the word appears in this document, i.e., the number of times that word exists in this document. For example, provided that the index of word “sun” is <(2, 3), (6, 2), (8, 6)>, this means that the word “sun” appears 3 times in No.2 document (that is to say there are 3 suns in No.2 document), 2 times in No.6 document and 6 times in No.8 document. In this system, however, Document Number referred to is actually the difference between Document Numbers, i.e., the difference between the latter Document Number and the previous one. For example, the index of word “sun” in this system is expressed as <(2, 3), (4, 2), (2, 6)>, where the position of Document Number of the second index term is 4 (which is the difference of the Document Number of the second original index term and that of the first one), the position of Document Number of the third index term is 2 (which is the difference of the Document Number of the third original index term and that of the second one). Due to the fact that the retrieval method of this system is passage retrieval, actually the Document Number of index term is the number of passages, i.e. the first number of an index item is the difference of passage numbers.

In the present invention, a passage contains N paragraphs, so the word number of an index term (the second component of an index term) is the number of times that a word occurs in N paragraphs. Such an index substantially means that while comparing a document with query in document search phase, the system is to compare the words in the scope of N paragraphs with query. In addition, among the passages formed by the method of the present invention, adjacent passages have overlap. Adjacent passages at most have N−1 paragraphs to overlap. This also means that while comparing a document with query, window moves down a paragraph each time, namely means that the passages pointed to by the first component of index terms have overlap. For relevance of a document to query is estimated mainly by index in document search phase. The characteristic of the information retrieval method is substantially reflected by index. In fact index implicitly indicates which part of document is compared with query. In addition, distribution and overlap of passages are implicitly reflected by index. From a certain angle, index can be regarded as another form of documents (or passages). This kind of form removes the information that is irrelevant to the process to be executed. For example, in the implementation of the present invention, index can be regarded as another form of passages. In this kind of form, the position information of words in passages is removed. The information of the number of times that words occur in passages is reserved, for only the information of the number of times that words occur is needed in the latter document search phase. Some information retrieval systems need the position information of words. There the index may include the position information of words in documents. Therefore, the index of the present invention may be the same as the index of other type of passages in form, but they are different in the significance and effect. Just as described above, index is another kind of manner of expressing documents (or passages), so the index of the present invention is different from the indexes formed based on whole documents (they can be regarded as representing whole documents) and other types of passages (they can be regarded as representing those kinds of types of passages). Just based on such index, a high precision is gotten in latter document search phase.

The index generation process is as described below: A document is taken out from a document set, then the system analyses the document and determines the passages that the document includes. In the document, each N consecutive paragraphs form a passage. In the specific implementation of the present invention, after each N consecutive paragraphs in a document form a passage, again the system takes the first N−1 paragraphs of the document to form a passage which is referred to as the first passage, takes the last N−1 paragraphs of the document to form a passage which is referred to as the last passage. The reason for taking N−1 paragraphs at the beginning and end of a document again to form passages is that this gets a good accuracy in practice. Intuitive explanation of the method is: in middle of a document, topic discussed in a paragraph can be “leaked” in two directions—upwards and downwards, but at the beginning and the end of a document, a topic can be leaked only towards a direction. Taking N−1 paragraphs respectively at the beginning and end of a document to form two passages should be understood as a selective step of the implementation of the present invention, not a necessarily included step. In the specific implementation of the present invention, paragraphs are paragraphs in broad sense. The title and abstract of a document are all regarded as paragraphs. For example, if a document has a title and an abstract, then the first passage of the document comprises the title of the document, the abstract of the document and the first N−3 paragraphs of the document. Just as previously described, the method forming passages in the present invention corresponds to existing a window that moves over a document. The window contains N paragraphs. Each time, the window moves down a paragraph. At the beginning and end of the document, the window can contain N−1 paragraphs. Each (different) word appearing in a passage will result in the generation of an index term, and the first component of the index term is the difference between the number of this passage and the number of the passage that this word previously appeared (it is passage number that the word exists in case of the first occurrence of said word). The second component of the index term is the occurrence number of this word in this passage. In the implementation of the present invention, the preferred value of N is 5.

The index finally generated by this system is stored on a hard disk. During generation of indexes, if each index term created needs to be stored in a corresponding position on a hard disk, it may likely require random access, which is time-consuming, resulting in a very slow index creation process. Indexes created cannot be temporarily stored in memory as currently most PCs only have 256 M to 512 M of memory. The index of a 5G set of document can occupy up to 400 M, which exceeds memory capacity. On this account, this system adopts a compromise. An index term is temporarily stored in memory whenever it is generated. The index in memory is merged to the overall index file when the index length exceeds a certain length Max_Block_L, i.e., stored to hard disk. In this implementation, Max_Block_L is set to 10 M. Since the index in memory is not the full index, but only a part of the full index. It is supposed to be formed by some (successive) passages among all passages, i.e., this is a partial index, and therefore we call it a partial index. Hereinafter the (successive) passages forming a partial index are referred to as a block. Accordingly block referred to hereinafter is the passages involved in partial index. For the purpose of easy identification, we call the index finally generated for all documents a general index. In this system, the main process of index generation is to repeatedly generate partial indexes, and then chains the partial indexes to general index. Upon the completion of processing all documents (or passages), a general index is formed.

This system generates indexes by scanning the document set in two passes. The first time scan mainly records the index length of each word, with which the initial position of the index of each word can be computed. The philosophy is such that the initial point of the index of following words is the sum of the index lengths of all previous words, necessarily the initial point should, for easy access of index, get start from an integral byte, if not, the initial point is adjusted to get start from an integral byte. This system defines that the initial point of the word index in the general index must start from an integral byte. In the implementation of the present invention, index length is represented by bit rather than byte. After the initial position of the index of each word is gotten from the first time scan. The memory space can be pre-allocated for partial index, and hard disk space can be pre-allocated for general index such that the index terms of words can be stored to respective positions during the second time scan.

In the first time scan, two types of index lengths are recorded, one is the length of index of each word in a general index, and the other is the length of index of words in a partial index. During the generation process of the general index, a number of partial indexes are likely generated, and the index word length of word varies with partial index, consequently a partial index parameter list is set up which records some parameters of each partial index, including passage number Ipsg_num concerned in partial index, partial index length BlkInvLen, word number WrdNum which is the total number of words appeared up to now, not only the number of words appearing in the block corresponding to the present partial index. The reason for using all words appeared up to now is as followed: if the words only appearing in the block are used, as the words appearing in different blocks may be different, for each block, the words appearing in it may need to be record, this may need to record a number of set of words. If all words appeared up to now are used, then only words appeared up to now need to be recorded, namely only one set of words need to be recorded. It can be determined by the partial index parameters (the number of index term and the length of index) of the word whether a word appears in a block. The partial index parameter list also includes the number of index terms and index lengths of each word in this partial index. Each Word referred to herein also refers to all words appearing up to now, and not merely those words appearing in this block. If a word does not appear in this block, its number of index terms and index lengths in this block are both 0.

The first time scan does not generate any index, only computes some parameters of the word index, including numbers of index terms (for general index and partial index), and length of word index. These parameter records are preparation for practical generation of indexes for the second time scan. Initial point of the index of each word can be determined from index length of its previous words. Essentially the first time scan is mainly to predetermine the length of word index, including the length in partial index and that in general index. Getting known of the index length of each word will find the initial point of the index of each word by calculation. The philosophy is that the initial point of the index of word followed is the sum of index lengths of all previous words. The first time scan finally forms a dictionary, too. Said dictionary contains words, the number of indexed terms for each word, the initial point of this word's index in the general index, and the length of word index in the general index. In the document search phase, the index information of the words in query can be gotten by consulting the dictionary. During the practical generation of an index for the second scan, firstly the partial index is generated, which is stored in memory, and then the partial index is linked to general index. This process is repeated until general index is generated.

The implementation of the present invention provides an instruction to complete above-mentioned process. This instruction has an input parameter, namely said N. The system executes this instruction to determine passages and form index.

Upon generation of an index, the system will search relevant documents in terms of the query. What this system adopts is a ranked-query, i.e., the query is compared with all passages, and then the document or passages are ranked by relevance from high to low. This system estimates the relevance of each passage to query in terms of the cosine degree of similarity, wherein the more the cosine value is, the higher the relevance of a passage to query is; contrarily the less the cosine value is, the lower relevance of a passage to query is. The passage with more cosine values ranks ahead, the one with less value ranks rearwards. Finally the passages are ranked in terms of their cosine values from high to low. The output of this system is documents, not passages. The ranking of a document is determined by the rank position of the passage it includes with the highest cosine value. The computing formula of cosine degree of similarity is as below:

$$\begin{matrix}cosine ( Q , {P}_{p} ) = \frac{1}{{W}_{p} {W}_{q}} {\sum }_{t ∈ Q ⋂ {P}_{p}} ( 1 + {log}_{e} {f}_{p , t} ) \cdot {log}_{e} ( 1 + \frac{N}{{f}_{i}} ) & ( 1.1 ) \\ {W}_{p} = \sqrt{{\sum }_{t = 1}^{n 1} {( 1 + {log}_{e} {f}_{p , t} )}^{2}} & ( 1.2 ) \\ {W}_{q} = \sqrt{{\sum }_{t = 1}^{n 2} {[ {log}_{e} ( 1 + N / {f}_{t} ) ]}^{2}} & ( 1.3 )\end{matrix}$$

To facilitate the description hereinafter, we assume the summation in formula (1.1) as

$${S}_{p} = {\sum }_{t ∈ Q ⋂ {P}_{p}} ( 1 + {log}_{e} {f}_{p , t} ) \cdot {log}_{e} ( 1 + \frac{N}{{f}_{t}} ) \qquad ( 1.4 )$$

In document-based retrieval, the position of Wp is Wd, where d represents document. Since the retrieval herein is passage retrieval, we use Wp instead of Wd. In the formula, Q represents query, Pp represents Number p passage, cosine (Q, Pp) represents the cosine degree of similarity of query and Number p passage, cosine value represents the matching degree of Q and Pp, fp,t represents the number of word t appeared in Number p passage, ft represents the number of passages where word t appears, N represents the total number of all passages, N1 represents the number of different words appeared in Number p passage, N2 represents the number of different words appearing in the query. Long queries and long documents contain more words, the summation value Sp may be greater than that of short query and short document, therefore in the formula it is divided by Wp and Wq for the purpose of eliminating the effect. Wq is identical for a query and the objective herein is only to compare the magnitude for ranking. On this account Wq can be removed from the formula. In terms of the processing methods of Wp, there are two methods to implement the document search phase of this system. The first one is to compute the cosine degree of similarity by way of directly using precise Wp. In this way, after the Sps of all passages is gotten, the Wps are read into memory from hard disk one by one. Whenever one Wp is read into memory, the cosine degree of similarity of Number p passage and query is determined by computing Sp/Wp. The second method is to approximate Wp's value with an (8-bit binary) integer, i.e., Wp's values of all passages is approximately converted into an integer value. In the specific implementation of the present invention, after the index forms, precise Wp value and approximate Wp value are computed based on the index. Then they are stored into hard disk. In the document search phase, all approximate Wp values are read into memory and the cosine degree of similarity is computed firstly with these approximate Wp values. Hereinafter, the cosine degree of similarity computed with an approximate Wp value is referred to as an approximate cosine degree of similarity (or approximate cosine value for short). The cosine degree of similarity computed with a precise Wp value is referred to as a precise cosine degree of similarity (or precise cosine value for short). Firstly the system commences an initial ranking with approximate cosine values, and then proceeds to calculating precise cosine value with precise Wp value. Finally the system proceeds to ranking and output document in terms of precise cosine values. In the second method, when finally the precise cosine value is computed, it is not required to compute precise cosine values of all passages, on this account only a part of passages' precise Wp values are involved, not all passages' precise Wp values involved, only the precise Wp values of those passages ranking ahead are involved in order to rank. The precise Wp values of those passages ranking rearward are not further read, namely, when precise cosine value is computed, it is not required to read each precise Wp values from hard disk, only the precise Wp values of those passages that approximate Wp values rank ahead need to be read. So in the second method, only a part of passages' precise Wp values are involved, not all passages' precise Wp values involved. The second method may be faster than the first method that only uses precise Wp values, for all approximate Wp values are in the memory simultaneously, and it is not required to read each precise Wp into memory one by one from hard disk. But this method will occupy a certain quantity of memory space. In the first method, as Wp is a floating-point number, and reading all of them into memory will occupy more memory space. A precise Wp value is read each time when a cosine value is computed, so the first method will be slower than the second method. This will be disserted on in the specific implementation section. For computing methods of approximate value of Wp, refer to Ian H. Witten et al., “Managing Gigabytes: compressing and indexing documents and images (second edition)”, Morgan Kaufmann, 1999, pp. 203-206. Specifically, provided that the number of bit of approximate Wp's integer value is set to b, there are 2.sup.b b-bit binary numbers. Assume the minimum value of Wp is L and the maximum is U, and “equipartition” the interval [L, U] with multiplication. Each equi-partition is

$$B = {( \frac{U}{L} )}^{{2}^{- b}} ,$$

assume

$$C = ⌊ {log}_{B} ( {w}_{p} / L ) ⌋ = ⌊ \frac{log ( {w}_{p} / L )}{log B} ⌋$$

Then the approximate value of Wₚ is gₚ=L×B^{C}

For a specific document (or passage) p, gₚ≦wₚ. Therefore, the cosine value determined with approximate Wp value is greater than or equal to the precise cosine value (in Formula 1.1, it is divided by Wp). Provided that f(c)=L×B^{C}, then yield gₚ=f(c)≦wₚ≦f(c+1). That is to say Wp falls in the interval composed by two adjacent approximate integers. This system adopts one byte, i.e., 8-bit binary integer, to approximate Wp, therefore b=8.

It is should be understood as a specific implementation of the present invention rather than a restriction to estimate the relevance of documents to query in terms of the cosine degree of similarity.

In the implementation of the present invention, an instruction is provided to execute the function to search documents. The instruction searches the set of documents and returns the documents that are thought to be relevant to the query. The number of documents to be returned to user after making search is set also by the instruction.

In the implementation of the present invention, another instruction is provided to compute Wp and the approximate Wp's value. The instruction computes Wp and the approximate Wp's value of each passage and stores them into hard disk. The specific procedure to compute Wp and the approximate Wp's value is described below.

When this system establishes an index and searches documents, stemming shall be done for each word. For example, regarding the significance, book and books are the same word, but they appear as two words regarding the written forms due to the difference of singular and plural forms, however, after stemming, books is converted to book (suffix s is removed), two words turn into the same one, during this system's establishment of index, the calculation of occurrence number of a certain word is actually to compute the occurrence number of word (actually the stem) upon the completion of stemming. For example, on the assumption that a document (or passage) contains 1 book and 1 books, without stemming, the occurrence number of book is 1; whereas after stemming, the occurrence number of book is found to be 2. In the document search phase, stemming shall also be done for words in query. For stemming methods adopted by this system, refer to Porter, M. F., “An algorithm for suffix stripping”, Program, 14(3): 130-137, 1980. In the description and diagrams hereinafter, word refers to stemming processed word, unless otherwise specified. Stemming is carried out when reading each word, every time when reading a word, accordingly it will be stemming processed.

### BRIEF DESCRIPTION OF THE DRAWINGS

FIG. 1 is a structural drawing which shows the specific environment implementing this invention.

FIG. 2 is a schematic diagram showing the relations between general index, document (or passage) and partial index.

FIG. 3A and FIG. 3B together are the flow diagrams of the first time scan during the index generation phase.

FIG. 4 is a schematic diagram of partial index parameter list.

FIG. 5 is a structural schematic diagram of dictionary in memory.

FIG. 6 is a flow diagram of the second time scan during the index generation phase.

FIG. 7 is a schematic diagram showing the link of partial index into general index.

FIG. 8 is a flow diagram for determining passages and indexes of words in the passage.

FIG. 9 is a schematic diagram showing the manner of forming passages.

FIG. 10 is a flow diagram for determining Wp and Wp's approximate value.

FIG. 11 is a flow diagram for determining the approximate value gₚ of Wp.

FIG. 12A and FIG. 12B together are flow diagrams of the first type of implementation method in document search phase.

FIG. 13A and FIG. 13B together are the flow diagrams of the second type of implementation method in document search phase.

FIG. 14 is the flow diagram for determination of Sp (for calculation of Sp, refer to Formula 1.4).

### DETAILED DESCRIPTION OF THE PREFERRED EMBODIMENTS

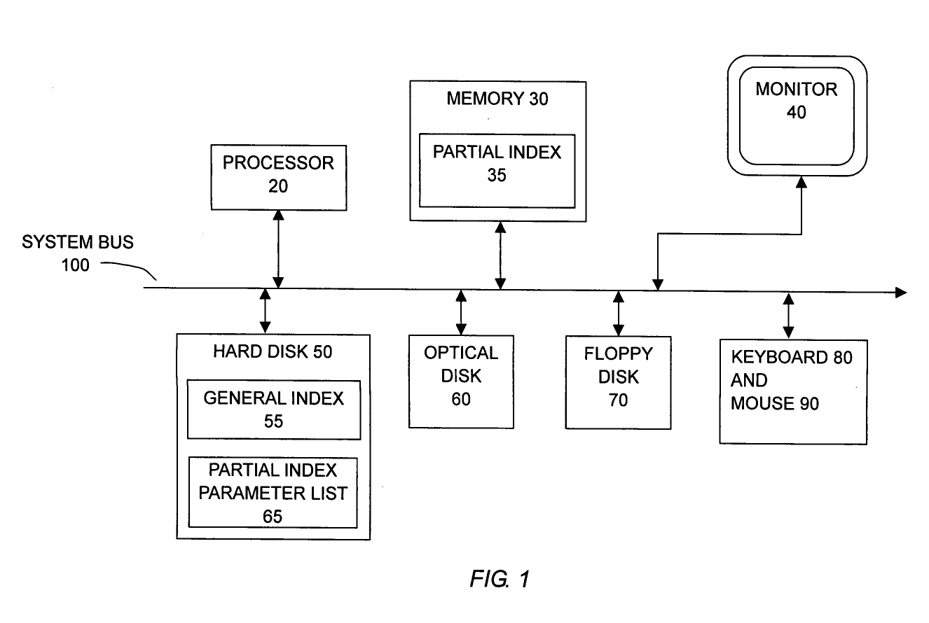

FIG. 1 is a structural drawing which shows the specific environment implementing this invention. It comprises system bus 100, processor 20, internal memory 30, display 40, hard disk 50, optical disk 60, floppy disk 70, keyboard 80 and mouse 90. Partial index 35 is stored in memory 30, and the general index 55 generated by system is stored in hard disk 50. Partial index parameter list 65 is stored in hard disk 50. In the partial index parameter list there are some essential parameters stored for generation of partial index. This environment can be understood as a PC system or workstation. The environment herein is only a specific environment implementing the present invention. The implementation of the present invention is not confined to this configuration. For example, this system can also connect to a printer. This structural drawing only shows the parts necessarily emphasized, without content of general knowledge. For example, operating system generally is stored on the hard disk, which is fetched to memory for running during running of computer, however no operating system drawn in hard disk 50 herein, because it is general knowledge for one skilled in the computer art. In addition the code of this system is also stored on hard disk, and which will be fetched into memory when running. FIG. 1 shows partial index 35 is stored in memory 30, emphasizing partial index 35 is generated in memory. General index 55 is on hard disk 50, emphasizing general index 55 is finally formed and stored on hard disk 50. Without doubt, any data or code to be used will be fetched into memory first, this is general knowledge for one skilled in the computer art, and therefore this schematic has not drawn up correlated processes. In the implementation of the present invention, the set of documents is stored on the hard disk. The set of documents can also be stored on other computer-readable medium such as optical disk etc. The operating environment as shown in FIG. 1 can also be linked to a network. The set of documents can also be stored in the server of the network.

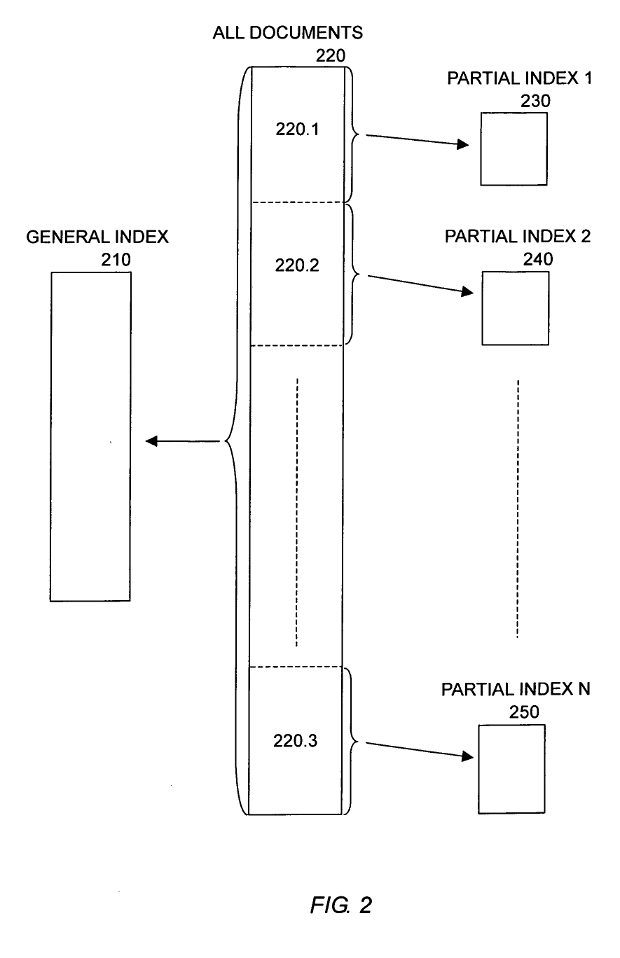

FIG. 2 is a schematic diagram showing the relations between general index, document (or passage) and partial index. In the diagram, 210 for general index, 220 for document (or passage), 230, 240 and 250 for partial indexes, 220.1, 220.2 and 220.3 are for three blocks. General index is the index formed by all documents, and therefore general index 210 corresponds to all documents 220. Partial index is the index formed by partial (successive) passages, which corresponds to partial (successive) passages in a document set, in FIG. 2, 230 corresponds to 220.1, 240 corresponds to 220.2 and 250 corresponds to 220.3.

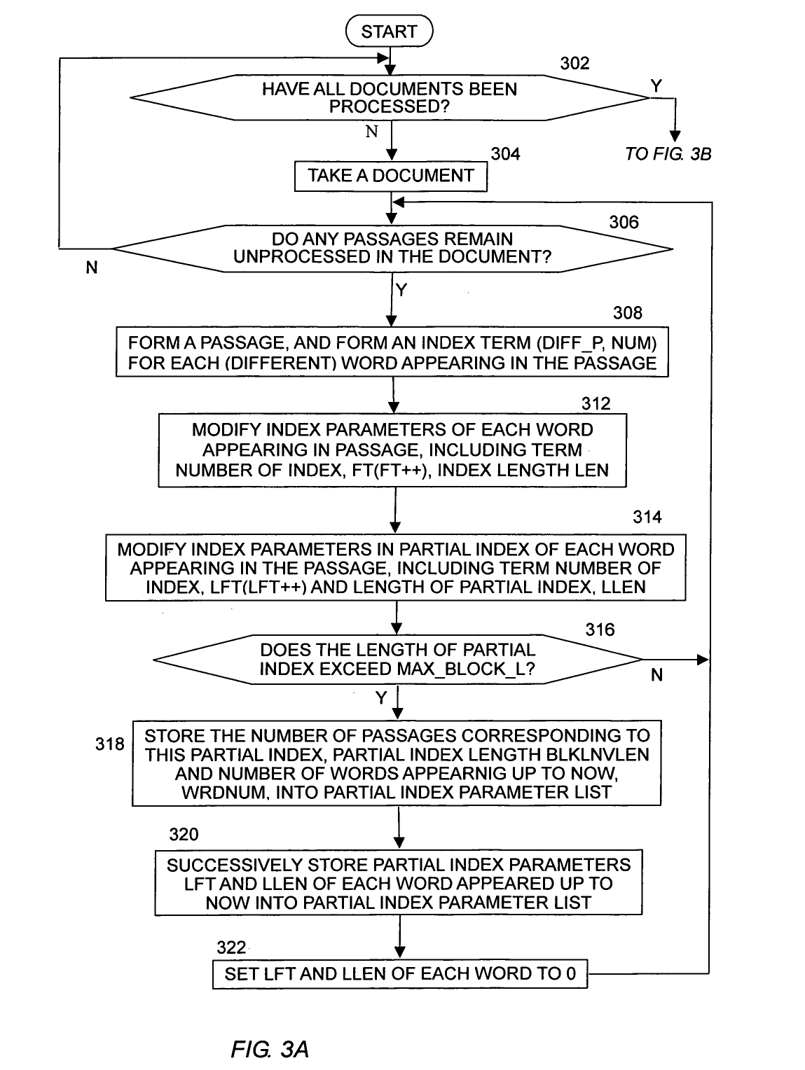

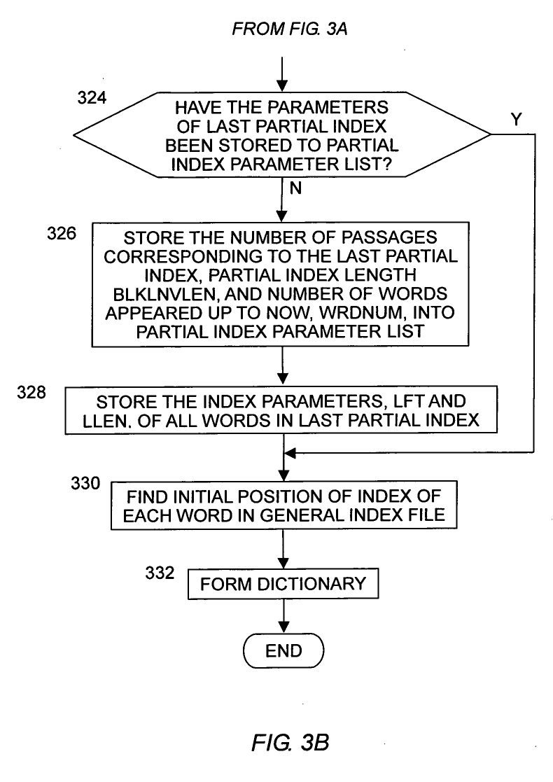

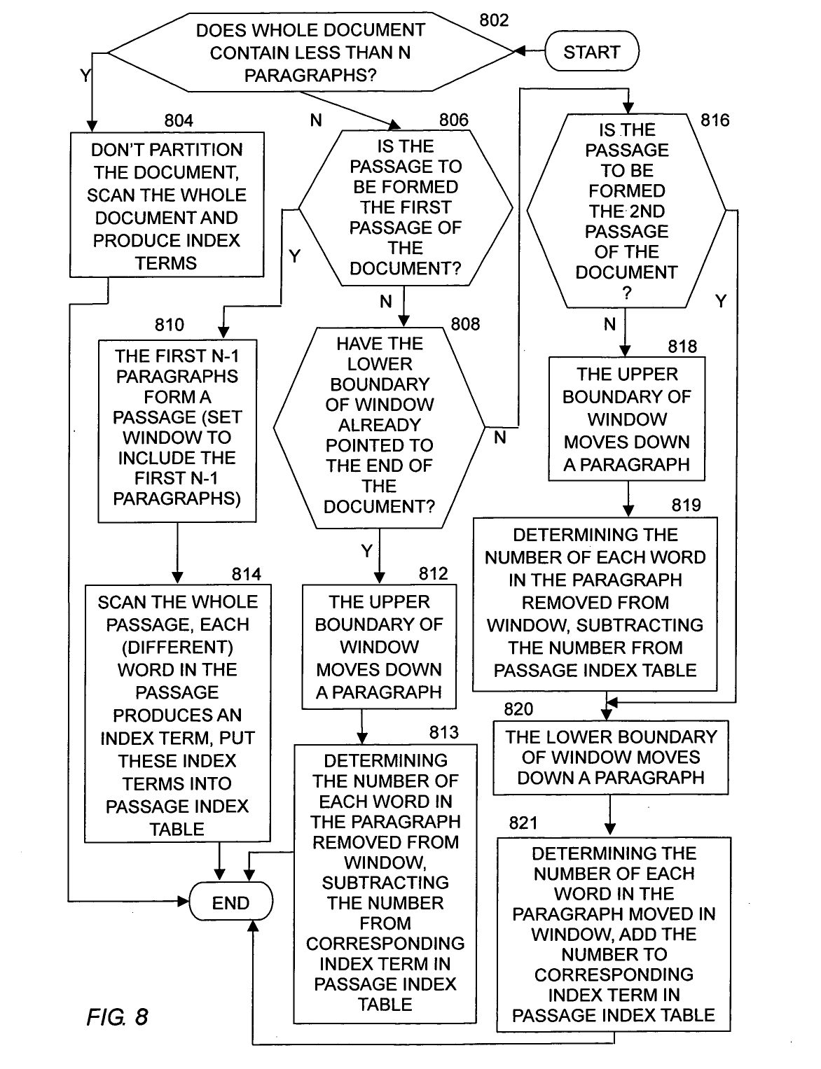

FIG. 3 is the flow diagram of the first time scan. Box 302 decides whether there is document to be processed, if all documents have been processed, the flow goes to box 324 (to FIG. 3B). If there is document to be processed, one document is taken out from the set of documents (304). The document is analyzed to see whether the passages of document have been processed (306), i.e., whether new passages can be generated in terms of the passage formation principle of the present invention, if all are processed (i.e., this document cannot have new passage formed any more), the flow goes to box 302. If there is still a passage not processed, a passage is then formed and each different word appeared in passage simultaneously forms an index term (diff_p, num)(308), for specific implementation of box 308, see FIG. 8. diff_p is the difference between this passage's number and a previous passage's number, num is the occurrence number of word in this passage. In step 312, the system adds 1 to the index term number ft of each word present in the passage, the length of word index is modified to the sum of original length and the length of this new index term. This system uses GAMMA encoding method to encode two quantities of index term, therefore index length is the sum of original length and the length of newly generated index term after GAMMA encoded. For GAMMA encoding method, refer to Ian H. Witten et al., “Managing Gigabytes: compressing and indexing documents and images (second edition)”, Morgan Kaufmann, 1999, pp. 116-129. Box 312 is to process general index parameters. Box 314 underside is to process partial index parameters. In step 314, the number of index term of each word, Ift, in partial index adds 1, and the partial index length of word, Ilen, is also modified in the same way as that in the general index length, as shown in the upside. Index term number Ift corresponds to the number of passages in this block where this word appears. And then box 316 decides whether the total length of index (summation of the lengths of partial indexes of all words) exceeds a preset length Max_Block_L, if not, the flow goes to box 306. If the length of partial index exceeds Max_Block_L, box 318 stores the corresponding parameters into partial index parameter list. Parameters stored include the passage number Ipsg_num involved with this partial index, length of partial index BlkInvLen, and the number of words appeared till the block corresponding to this partial index, WrdNum.

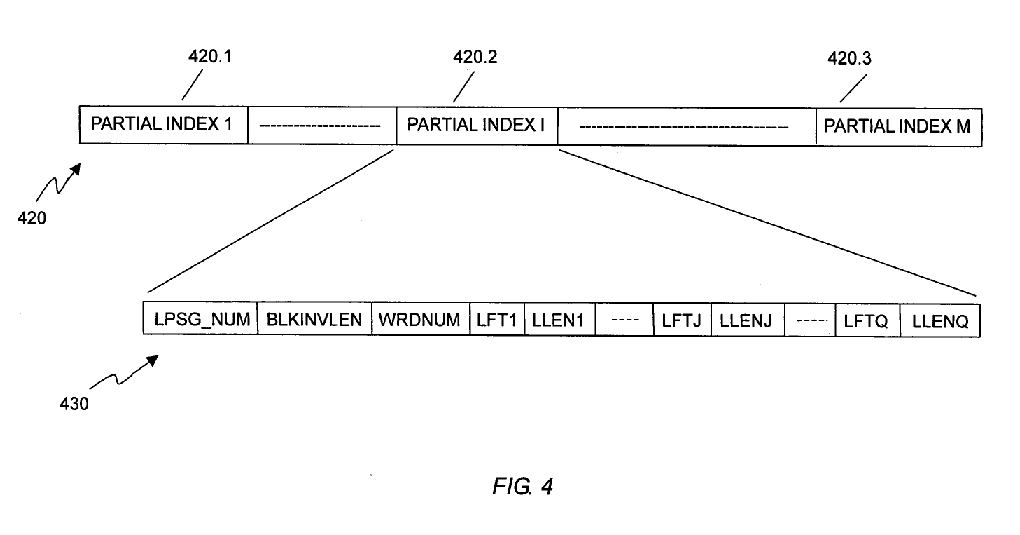

Additionally, the number of partial index terms in this partial index of all of words appearing up to now, Ift, and partial index length Ilen shall be successively put into partial index parameter list (box 320). Note that herein is not all of words involved with this partial index, but all of words present up to now beginning from the first (No. 1) passage. If a word does not appear in this block, but appears in the previous ones, its Ift and Ilen in this block are both 0, i.e., the corresponding entry of this word in partial index parameter list is 0, parameters Ift and Ilen of word are stored in partial index parameter list in precedence order of occurrence of this word. Partial index parameter list is as shown in FIG. 4. After box 320 performed, the flow goes to box 322, Ift and Ilen of all words are set to 0 such that the partial index parameters of next block can be formed. Then the flow goes to box 306. Box 324 identifies whether the last partial index parameter has been put into partial index parameter list, setup of this step is the existing of following two cases. The first case is, see box 316, when the last passage (i.e., the last passage of last document) is processed by the system, and if the total length of this partial index just exceeds Max_Block_L, then the partial index parameters of each word will be put into partial index parameter list. Note at this moment the passage is the last one of last document, that is to say, after processing this one, all documents have been processed, therefore, the procedure goes to box 302 (316→318→320→322→306→302) and at this moment the parameters of last partial index have been put into the partial index parameter list. The second case is that when processing the last passage, if the length of partial index (which is the last one) does not exceed Max_Block_L, then go to box 306, and the index parameters of this partial index are not put into partial index parameter list. Box 306 decides whether there is passage to be processed, because this is the last one, there are no more passages, the flow goes to box 302; since all documents have been processed, again the flow goes to box 324, here the parameters of the last partial index are not put into partial index parameter list, therefore, in such a case the parameters of this partial index shall be put into partial index parameter list, i.e., box 326 and box 328 are executed. Box 326 stores the passage number of last partial index, length of partial index, BlkInvLen, and the number of words appeared up to now, WrdNum, into partial index parameter list. By now since all documents have been processed, consequently the number of words, WrdNum, is the number of all of the different words included in the document set. Box 328 successively stores the parameters Ift and Ilen in the last partial index of all words into partial index parameter list. By this time all documents have been processed, and the total index length of each word has been determined, consequently the initial point of each word in the general index can be determined (box 330). The philosophy is that the initial point of the index of word followed is the sum of index lengths of previous words.

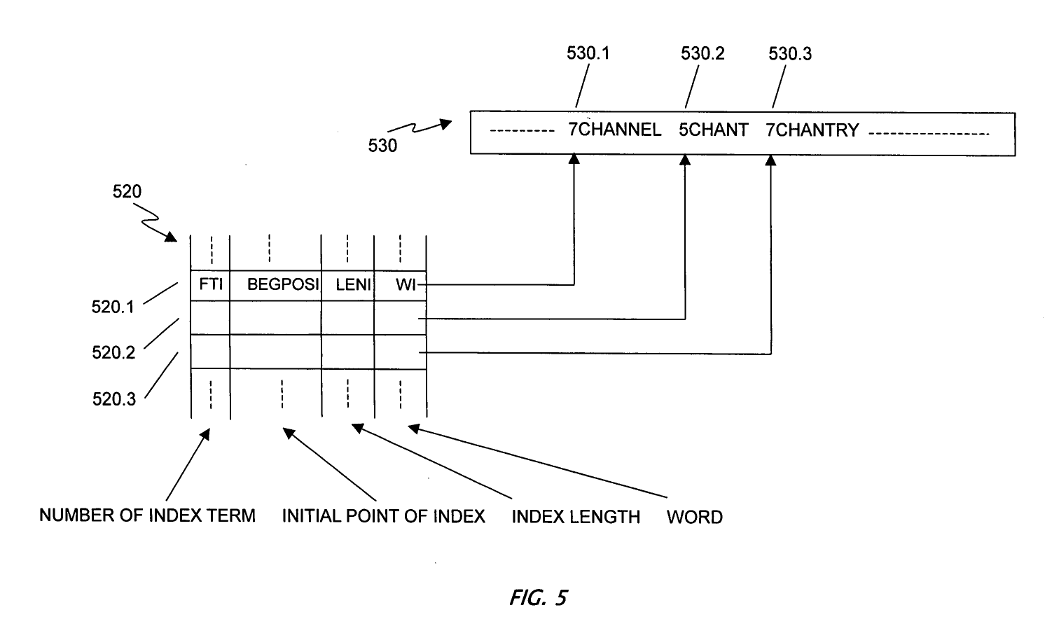

In the implementation of the present invention, index length is expressed in bit, but not byte. So this system defines that in general index, the initial point of index of each word must be multiple of 8, that is to say, the initial point of word index getting start from one byte, consequently the initial point of index of each word is adjusted to a multiple of 8. Box 332 is to form a dictionary, of which the structure is as shown in FIG. 5, including word, number of indexed terms of each word, initial point of word index (word index's position in general index file), and the length of word index. The dictionary, once formed is stored on hard disk. The dictionary is used in the document search phase, and at the start of a document search phase it is taken into memory. After box 322 is executed, the first time scan ends.

FIG. 4 is a schematic diagram of partial index parameter list. The parameters of each partial index are successively stored into the list. 420 is partial index parameter list. Parameter of partial index 1, 420.1, parameter of partial index i, 420.2, and parameter of the last partial index m, 420.3, are all stored in parameter list 420 successively. The detailed contents included in each partial index parameter entry are as shown in 430. The beginning are a few parameters of whole block, including the passage number Ipsg_num involved with partial index, length of this partial index, BlkInvLen, and the number of words appearing until this partial index, WrdNum, followed by the number of index terms and index length of each word appearing until this block, which respectively are Ift1, Ilen1, . . . , Iftj, Ilenj, . . . , Iftq, Ilenq.

FIG. 5 is a structural schematic diagram of dictionary in memory. 520 is an aggregation of dictionary entries, each entry of dictionary consists of word, index length, initial point of index and index's number of item. 520.1, 520.2 and 520.3 are three entries in dictionary, among which 520.1 comprises Number i word, wi; number of item of word wi's index, fti; word wi's index length, leni; and word wi's initial point, BegPosi. Here the word field, wi, is an indicator pointing to the position storing the word, wi corresponds to word channel. The storage format of words in the dictionary is shown in 530 where the first character of each word is the length of that word (i.e., the number of characters of word), followed by the word itself. All words are stored successively. There are 3 words (channel, chant and chantry) in 530, the numeric character ahead of each word is the length of this word, which are words corresponding to entries 520.1, 520.2 and 520.3, and their storage positions are respectively 530.1, 530.2 and 530.3. The dictionary's word field is an indicator pointing to the beginning position storing its corresponding word. Word field of entry 520.1 points to 530.1, word field of entry 520.2 points to 530.2 and word field of entry 520.3 points to 530.3. The dictionary entries are sequenced according to the words included in them. In the document search phase, Binary search is used to consult the dictionary.

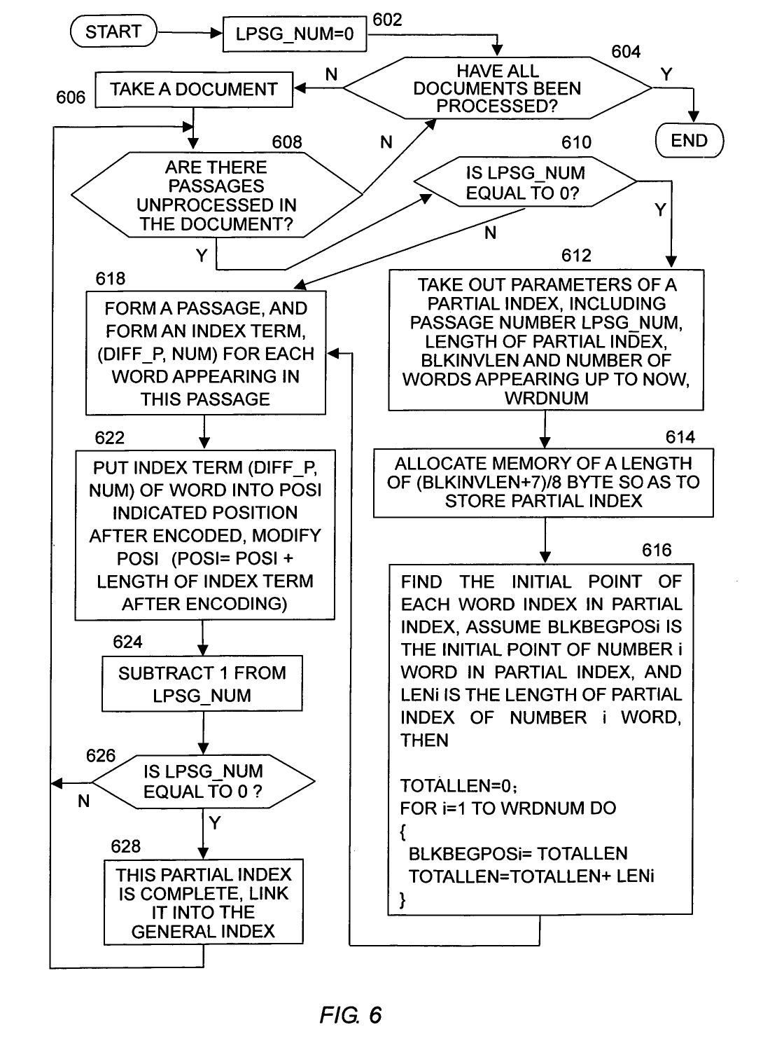

FIG. 6 is the flow diagram of the second time scan. The second time scan generates indexes on the basis of the first time scan. The first time scan records the index length of each word of each block, and records the length of each word's index in general index and determines the initial point of each word's index in the general index, and consequently the second time scan can practically generate an index.

The specific procedure is as below: box 602 sets Ipsg_num to 0, Ipsg_num represents the number of remaining passages which are not processed, and serves as a mark used for deciding whether parameters of the next partial index are to be taken out. Equaling 0 of Ipsg_num represents passages corresponding to a partial index, respectively have already been processed. Parameters of the next partial index need to be taken out for further processing. When the second time scan begins, Ipsg_num is set to 0, and then box 604 identifies whether the documents in a document set have been fully processed. If so, the process ends. If not, an unprocessed document is taken out (box 606). Box 608 decides whether there is any unprocessed passage. Namely, box 608 analyzes to see whether new passages can be generated in terms of the passage formation principle of this system, if all passages have already been processed (i.e., this document cannot form any new passages). The flow goes to box 604; if there is any passage remaining unprocessed, the flow goes to box 610. Box 610 identifies whether Ipsg_num equals 0 or not, if not, the flow proceeds to box 618; if yes, box 612 is executed. Box 612 takes out partial index parameters from partial index parameter list, including passage number Ipsg_num of partial index, partial index length BlkInvLen and number of words appeared until this block, WrdNum. After the partial index parameters are taken out, box 614 allocates (BlkInvLen+7)/8 bytes in memory in order to store partial indexes. BlkInvLen is the bit number of partial index but not the byte number; therefore it should be converted into a byte number (divided by 8). After that, box 616 finds the initial point for storing partial index of each word such that the indexes can be stored to respective positions. In a partial index, the initial point of word index is the sum of the indexes of all previous words, and it is not required for initial point of word index to be at an integral byte. In box 616, TotalLen is the sum of word index lengths. The procedure goes over to box 618. Box 618 forms a passage and generates an index term (diff_p, num) for each different word in passage. diff_p is the difference between this passage's number and the number of previous passages in which this word appears, num is the occurrence number of this word in this passage. For a specific implementation of box 618, refer to FIG. 8. Box 622 encodes word's index term (diff_p, num) and then store it to position specified by Posi, Posi is modified (Posi=Posi+length of index term after encoded). At the beginning, Posi points to the initial point BlkBegPosi of the index of Number i word, and with the storing of index terms, Posi gradually moves backwards. Upon the completion of processing a passage, Ipsg_num minus 1 (box 624). Box 626 identifies whether Ipsg_num equals to 0 or not, if not, the flow goes to box 608; if yes, i.e., Ipsg_num equals to 0, it means that passages involved with this partial index have already been processed, and partial index have been generated, box 628 links them into general index, the flow goes to box 608 for further processing. Boxes 604-628 are repeated to form partial index time and again and then link partial index into general index, general index then forms when all documents are processed.

The second time scan is executed on the same set of documents as the first time scan.

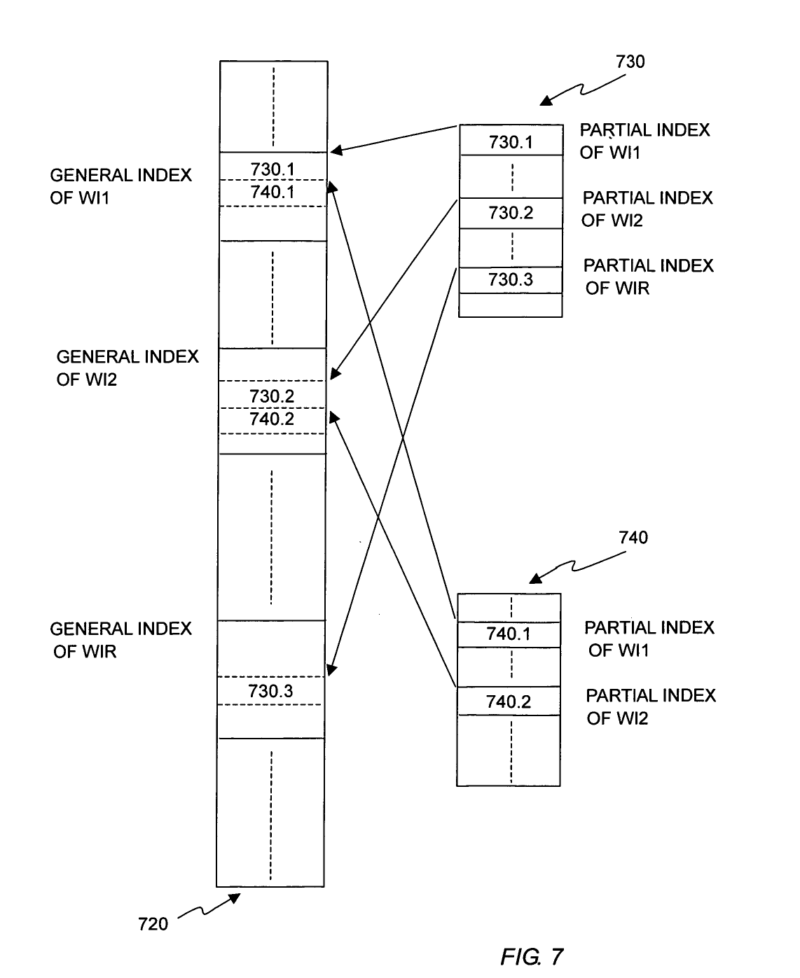

FIG. 7 is a schematic diagram showing the link of partial index into general index, in which 720 is general index, and 730 and 740 are two adjacent partial indexes respectively; 730.1, 730.2 and 730.3 are partial indexes respectively for words Wi1, Wi2 and Wir which are in partial index 730; 740.1 and 740.2 are partial indexes respectively for words Wi1 and Wi2 which are in partial index 740. In partial index 740 there is no index for word Wir (i.e., word Wir does not appear in the block corresponding to partial index 740), 730.1, 730.2 and 730.3 in partial index 730 are put into general index 720, and then 740.1 and 740.2 in partial index 740 are linked into the rear of 730.1 and 730.2.

FIG. 8 is a flow diagram for forming a passage and indexes of words in the passage. Box 802 identifies whether a document contains less than N paragraphs, if yes, then the document is not partitioned (box 804), the whole document is a passage. At this time, the whole document is scanned. Each (different) word in the document produces an index term. After box 804 performed, the process ends that forms passage and indexes of words in the passage this time. If the document contains N or more than N paragraphs, the system identifies whether the passage to be formed is the first passage of the document (box 806). If yes, the first passage of a document contains N−1 paragraphs, so the system takes the first N−1 paragraphs as a passage (box 810). The whole passage is scanned (namely the first N−1 paragraphs are scanned). Each (different) word in the passage produces an index term. The system put these index terms into passage index table (box 814). Passage index table is a set of index terms of all words that appear in a passage. The purpose that establishes passage index table is for reducing the number of times that a document is scanned in forming passages. For adjacent passages have N−1 paragraphs to overlap, the index terms of words in current passage is gotten by subtracting the number of each word in the most anterior paragraph in previous passage (namely the paragraph removed from window) from the corresponding index term in passage index table, and adding the number of each word in the paragraph just moved in window to corresponding index term in passage index table. If the passage index table is not established, and the whole passage is scanned each time, then intermediate paragraphs may be scanned N times (except for the paragraphs at beginning or end of the document). After box 814 performed, the first passage of the document is formed. The indexes in passage index table are just the indexes of the words appearing in this passage. In step 806, if the passage to be formed isn't the first passage of the document, box 808 identifies whether lower boundary of window has already pointed to the end of the document. If yes, the passage to be formed is the last passage of the document, then box 812 is executed. The last passage of a document contains N−1 paragraphs, so the upper boundary of window moves down a paragraph. In step 813, the index terms of the words in current passage is gotten by subtracting the number of each word in the paragraph removed from window from the corresponding index term in passage index table. For example, w is a word in the paragraph removed from window. The w's number in the paragraph is num1. There is w's index term in passage index table, say (diff_p, num). w's occurrence number in current passage is gotten by subtract num1 from num, namely the index term of w concerning current passage is (diff_p1,num−num1). diff_p1 is the difference between the number of current passage and the number of the passage that w previously appeared. If the condition of box 808 is not satisfied, namely the lower boundary of window does not point to the end of the document, then box 816 identifies whether the passage to be formed is the second passage of the document. If not, the passage to be formed is “intermediate” passage. Window moves down a paragraph. Namely the upper boundary of window moves down a paragraph (box 818). Box 819 subtracts the number of each word in the paragraph removed from window from the corresponding index term in passage index table. Again the lower boundary of window moves down a paragraph (box 820), box 821 adds the number of each word contained in the paragraph moved in window to the corresponding index term in passage index table. If a word is not formerly in passage index table, add index term of the word into the passage index table (box 821). If the condition of box 816 is satisfied, namely the passage to be formed is the 2nd passage of the document. The first passage only contains N−1 paragraphs, so the flow directly goes to box 820. In step 820, the lower boundary of window moves down a paragraph to make the passage contain N paragraphs. In step 821, procedure compares the words in the paragraph moved into window with the word in passage index table. If a word has been in passage index table, add the number of the word to its index term in passage index table. If the index item of a word is not in passage index table, add the index term of the word into passage index table. After box 821 performed, the process ends that forms passage and indexes of words in the passage this time.

In this implementation, passage index table is a Hash table. In the present invention, a preferred value of N is 5.

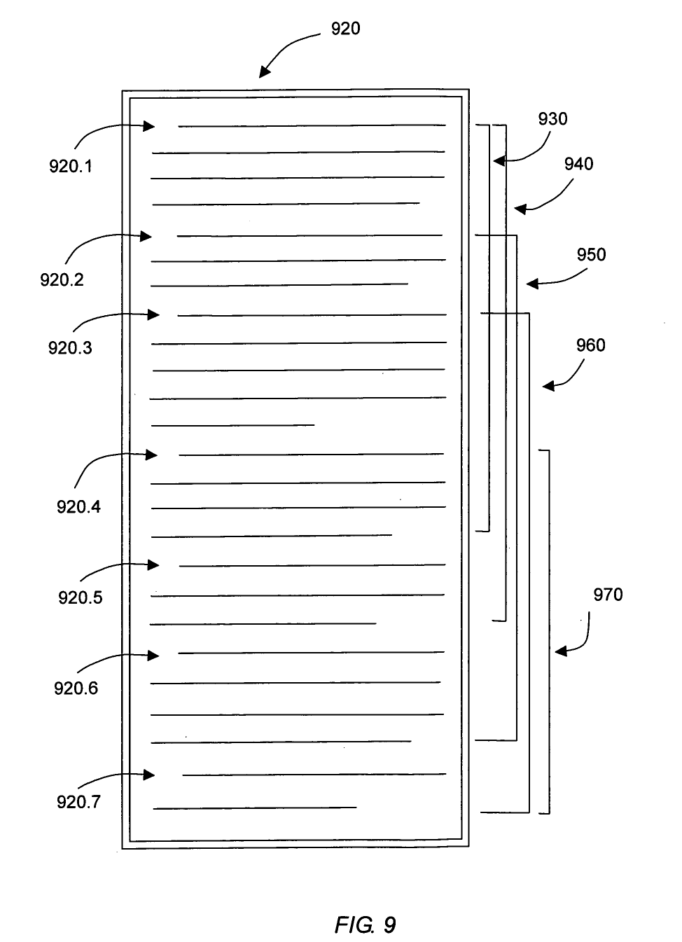

FIG. 9 is a schematic diagram showing the manner of forming passages. In the diagram, the value of N is set to 5. 920 is a document. Document 920 contains 7 paragraphs. They are respectively 920.1, 920.2, 920.3, 920.4, 920.5, 920.6 and 920.7. In the diagram, indent indicates the beginning of a paragraph. Five passages are formed for document 920. The five passages are respectively 930, 940, 950, 960 and 970. 930 is the first passage of the document. It is constituted of 920.1-920.4 four paragraphs. 940 is the second passage of the document. It is constituted of 920.1-920.5 five paragraphs. 950 is constitute of 920.2-920.6 five paragraphs. 960 is constituted of 920.3-920.7 five paragraphs. 970 is the last passage of the document. It is constituted of 920.4-920.7 four paragraphs.

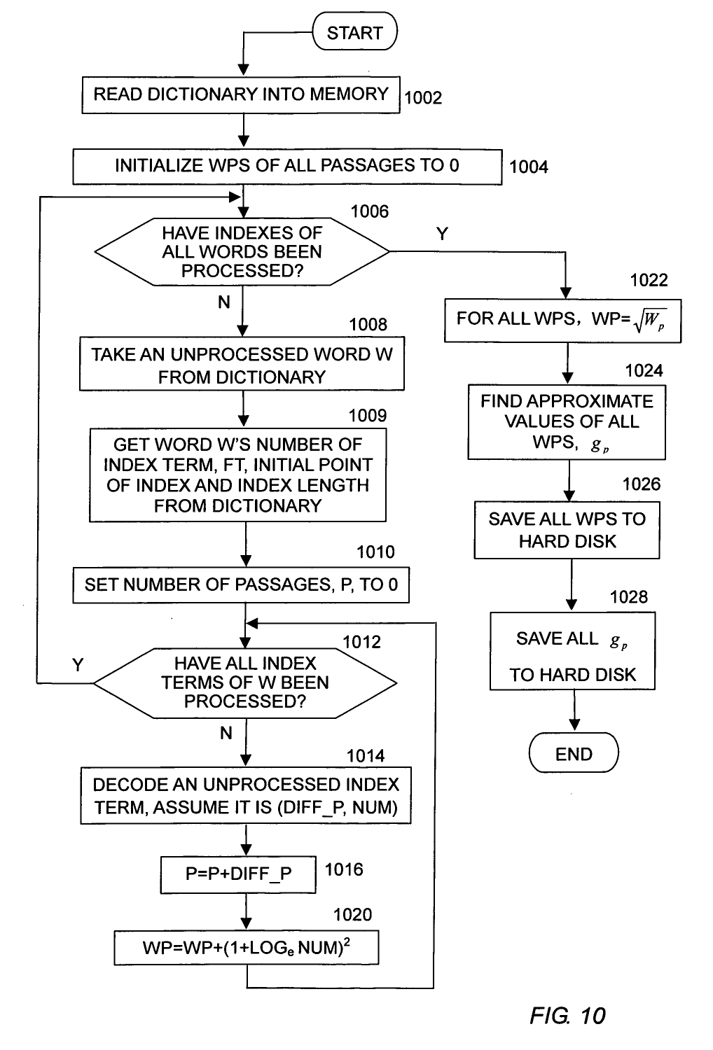

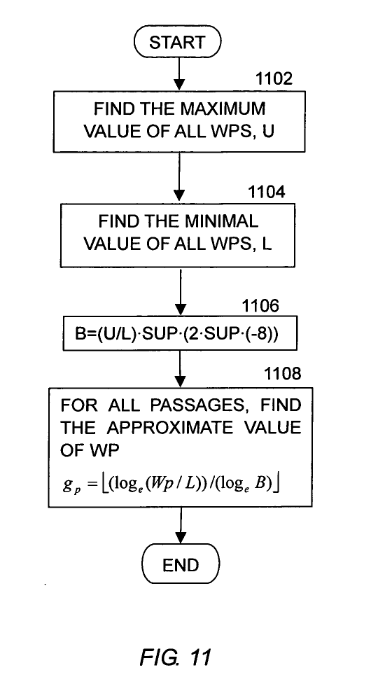

After the formation of the index, the precise value of Wp and approximate value of Wp are computed. FIG. 10 is the flow diagram of computing Wp and the approximate value of Wp. For formula determining Wp, see formula (1.2). Firstly, dictionary is read into memory (box 1002), and then all Wps are initialized to 0 (box 1004). Box 1006 identifies whether indexes of all word in dictionary have been processed, if yes, the flow goes to box 1022; if not, box 1008 takes a word W from the dictionary which remains unprocessed and box 1009 gets the number of index term, ft, initial point of index, and index length of this word W. Box 1010 sets passage number p to 0. Box 1012 identifies whether index terms of W have been fully processed, if yes, the flow goes to box 1006; if not, box 1014 is executed, and box 1014 decodes an index term (diff_p,num) remaining unprocessed, decoding herein refers to decoding directly made on the indexing file, not necessarily taking the whole index of W into memory. diff_p is the difference between the passage number of this index term and that of the last index term, therefore the passage number of this index term p=p+diff_p (box 1016), num is the occurrence times of this word in Number p passage, therefore Wp=Wp+(1+logₑnum)² (box 1020). Then the flow goes to box 1012. For all passages, box 1022 computes Wp=\sqrt{Wₚ}. Box 1024 determines the approximate value of Wp gₚ. For the specific determining method of gₚ, refer to FIG. 11. Box 1026 stores Wps of all passages into hard disk, and box 1028 stores all of gₚ into hard disk.

FIG. 11 is the flow diagram for finding the approximate value of Wp, gₚ. First of all, box 1102 finds the maximum values U of all of Wps, and box 1104 finds the minimum values L of all of Wps, and then box 1106 finds B=(U/L)·sup·(2·sup·(−8)). For each Wp, box 1108 finds its approximate value gₚ, gₚ=└(logₑ(Wp/L))/(logₑ B)┘.

Finally, the system will search relevant documents in terms of the query. There are two implementation methods in this system for document search. The first method is to compute the cosine degree of similarity directly with a precise Wp value, and then rank the documents. The second method is to compute the approximate cosine degree of similarity with approximate Wp value, and then compute the precise cosine degree of similarity of passages concerned to rank the documents.

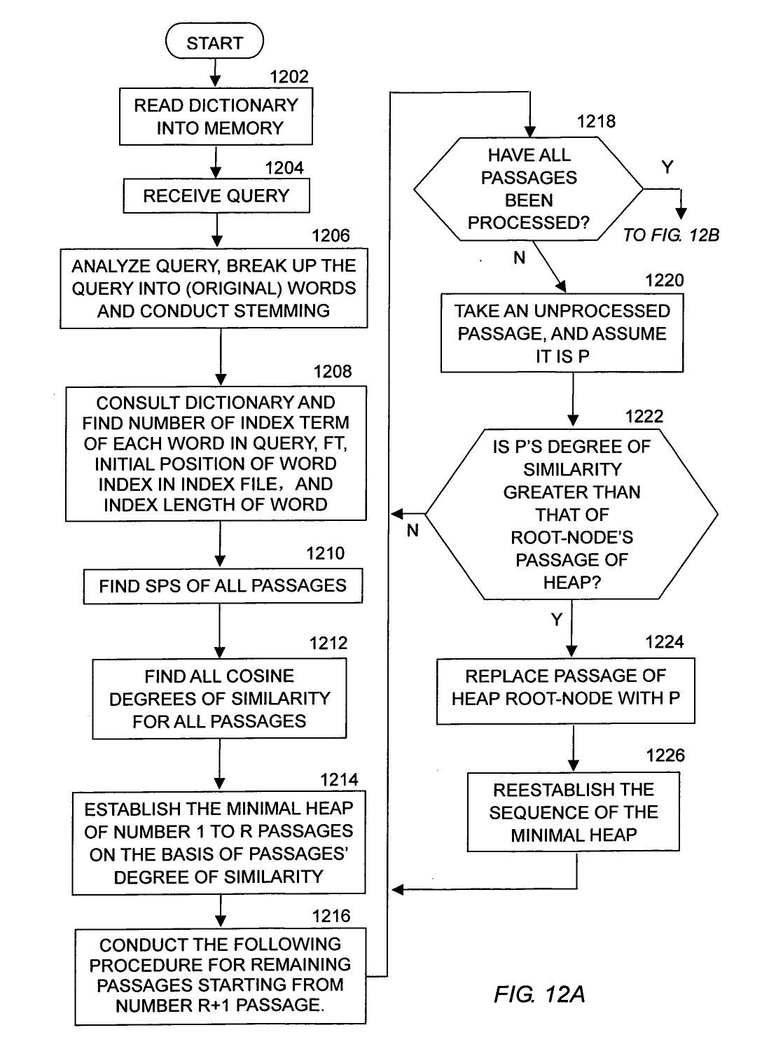

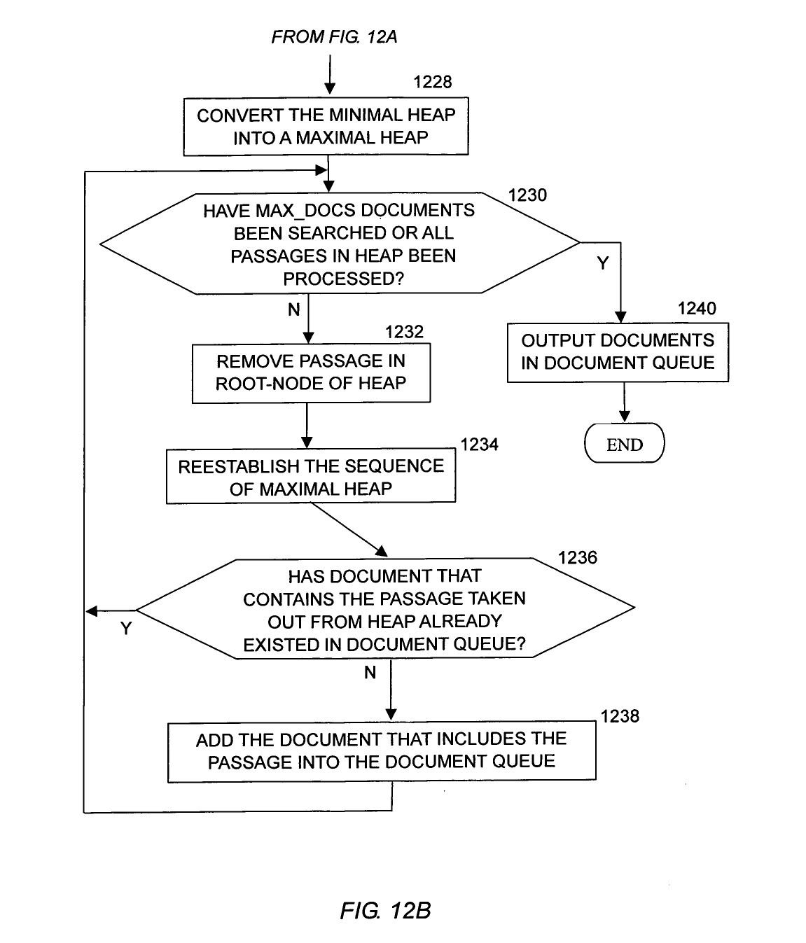

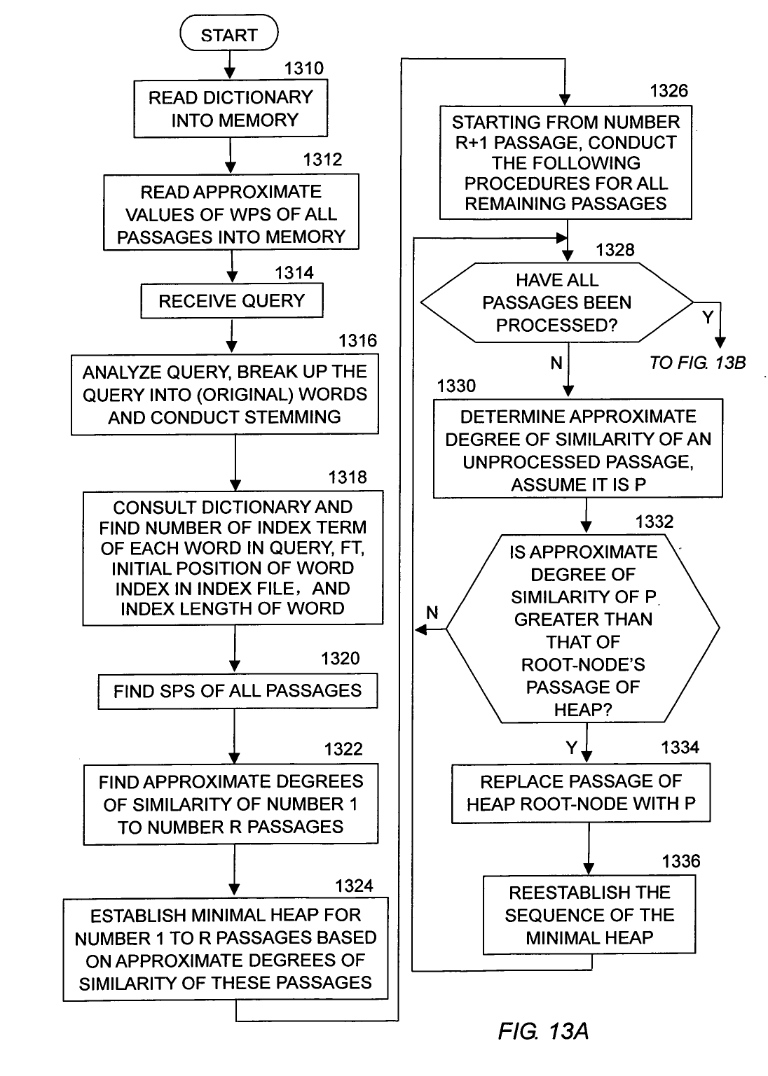

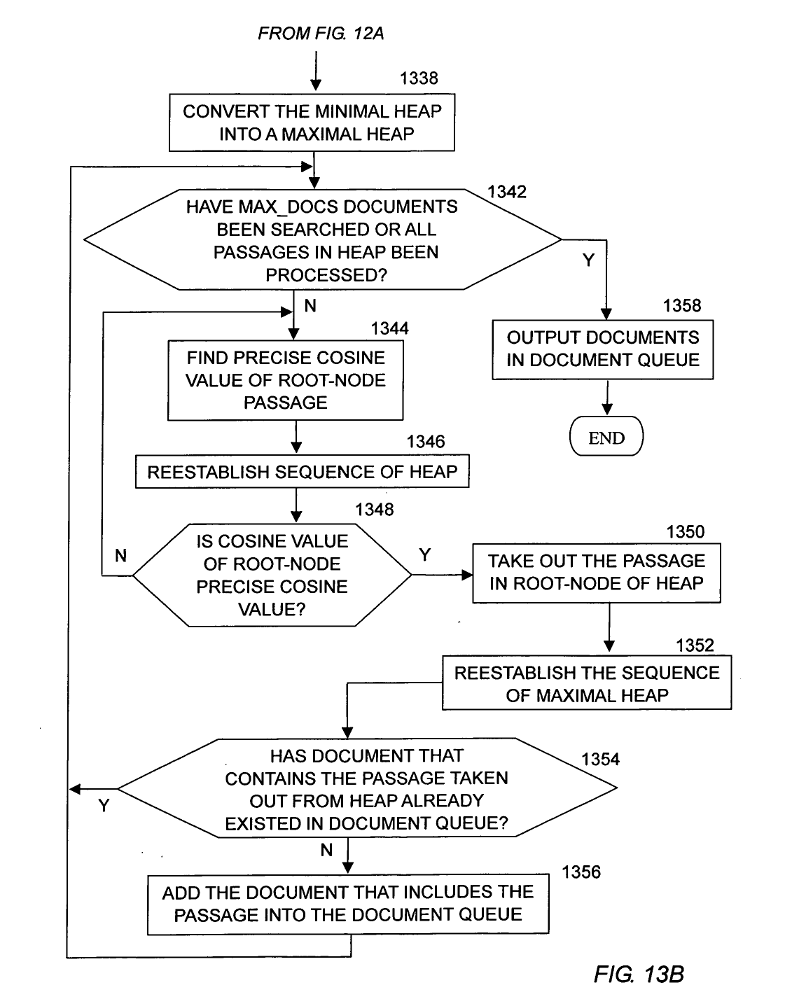

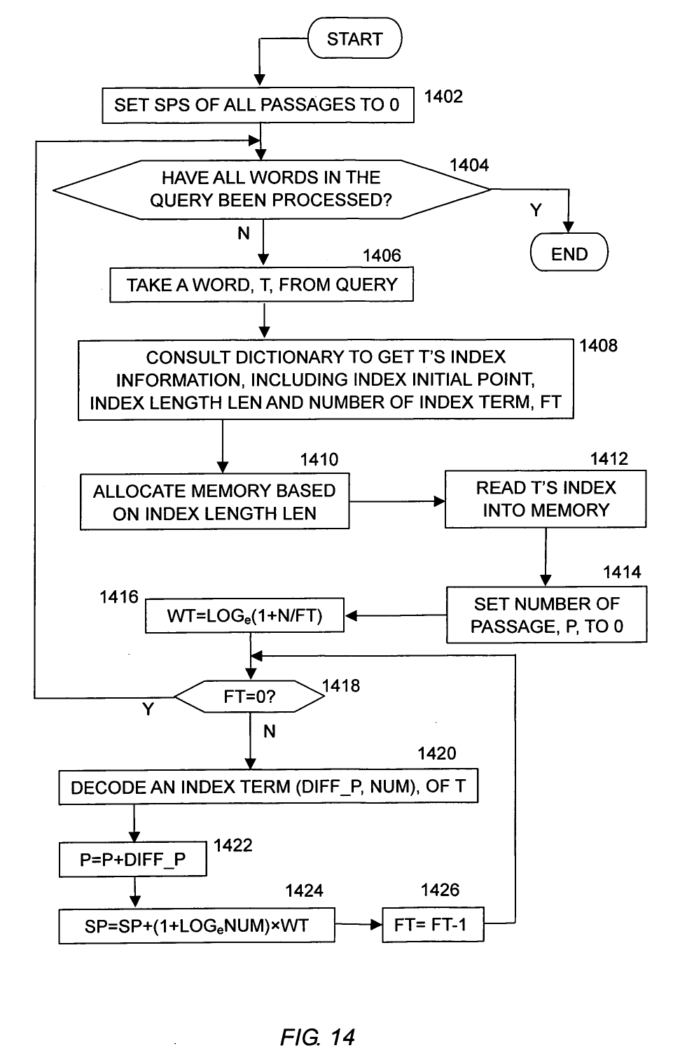

FIG. 12A and FIG. 12B are flow diagrams for the first implementation method. First of all, box 1202 puts the dictionary into memory, then box 1204 receives query, Box 1206 analyzes the query, breaks up the query into (original) words and conducts the stemming process, and next box 1208 consults the dictionary to get the index information of each word, including the initial position of word index in general index, length of word index and the number of item for word index. The procedure continues to execute box 1210, box 1210 finds Sps of all passages, for the determining method of Sp, refer to FIG. 14. And then box 1212 finds the cosine degree of similarity of all of passages, i.e., read each Wp sequentially from hard disk one by one, every time when reading a Wp, Sp/Wp is found to yield the cosine degree of similarity of a passage and query. In this implementation method, all Wps are used, i.e., read and involved in computation. However in the second implementation method, only some Wps are read for computation. The following boxes 1214-1226 are to determine the passages of which the cosine values are at top r. The program uses heap to implement this functionality. Box 1214 establishes the minimum heap of r passages of Number 1 to Number r passages based on the cosine degree of similarity of the passages (the minimum heap features that the root-node is less than its two sons). Where r is an artificially assumed value, which refers to how many passages will be finally reserved for ranking, i.e., in the end only r passages, not all passages, will be ranked, therefore, the preset r value shall be such that it can ensure a certain number of documents will be searched. Note that the final output of this system is not passages, but the documents. The ranking of documents previously referred to are determined by the rank position of the passage the document includes with the highest cosine value. Possibly there are a number of passages in a document ranked at the top, if r value is not great enough, a certain number of documents may unlikely be searched. For an extreme example, if we desire to search documents in a total number of r, and for this case we only rank r passages, and in which 2 of the passages pertains to one and the same document, in such a case we can only get documents in a number of r−1 due to the fact that the rank of a document is only determined by the passage with topmost rank. Therefore, the r-value should be greater than the number of documents desired. In this system, for cases that the desired retrieval documents not more than 1,000 in number, we set r to 30,000. Box 1216 starts from Number r+1 passage to compare the degree of similarity of each passage with that of heap root-node, if the cosine degree of similarity of a passage is greater than the value of root-node, this passage shall be ranked in top r. Therefore, the passage of heap root-node is deleted, and the degree of similarity of this passage is put into root-node, the cosine degree of similarity newly put into heap root-node is not necessarily the least one within the r passages in the heap. Accordingly, the sequence of heap is destructed, and a heap sequence needs to be reestablished, this process is repeatedly executed for the remaining passages, finally the passages in the heap are r passages with top cosine degrees of similarity. Box 1218 identifies whether all of passages have been fully processed, if yes, the flow goes to box 1228 (to FIG. 12B); if there are any passages remaining unprocessed, box 1220 get one of them and assume the passage is p, then box 1222 identifies whether the cosine degree of similarity of p is greater than that of the minimal heap root-node. If not, the flow goes to box 1218; if yes, the flow goes to box 1224. Box 1224 replaces the passage of root-node with p, the join of p may likely damage the sequence of the heap; and therefore box 1226 regenerates the heap sequence. Then the flow goes to box 1218. The following boxes 1228-1238 (as shown in FIG. 12B) are passages ranking from high to low in terms of cosine values, along with the ranking of documents. This system also implements this functionality with heap in the following procedure: box 1228 processes the previous minimal heap to convert it to a maximum one (maximum heap refers to the heap of which the root-node value is more than its two sons' values), the root-node value of the maximum heap is the maximum value in the heap, successive exporting of passages of root-node corresponds to top-down ranking of passages in terms of cosine values. Box 1230 identifies whether a certain number of documents (Max_Docs) have been searched or whether all of passages in heap have been processed, Max_Docs is the number of documents desired to be searched, for example, if 1000 documents are desired to be searched, then Max_Docs equals 1000. If the conditions of box 1230 are satisfied, the documents searched are outputted (box 1240), and the searching process ends. Otherwise, the passage of heap root-node is taken out from heap (box 1232) and then the heap sequence is re-established (box 1234). Every time when a passage is taken out, it is checked to see if the document containing this passage has been ranked (i.e., whether the document has been put into the document queue) (box 1236), if not yet, the document is added to the document queue (box 1238), and then the flow goes to box 1230. If the passage-corresponding document has already been ranked (already in document queue), indicating that there has been other passages in this document have been selected previously, since document is ranked in terms of its passage with topmost cosine value. This document is not necessarily put into the document queue again. The flow goes directly to box 1230. boxes 1230-1238 is repeated until Max_Docs documents are contained in the document queue, or all passages in the heap have been fully processed. Finally the documents of the queue are outputted (box 1240). Note it is possible that there are no Max_Docs documents searched until the processing of passages in the heap is complete. This indicates the r-value is insufficient, and should be increased.

See FIG. 13A and FIG. 13B for the second type of implementation method in the document search phase. First of all, the dictionary is fetched into memory (box 1310), and then the approximate value of Wp of each passage is read into memory (box 1312). Query is read in (box 1314), Box 1316 analyzes the query, breaks up the query into (original) words and conducts the stemming process, and then box 1318 consults the dictionary to get the index information of each word, including the initial position of word index in general index, length of word index and the number of item for word index ft. The number of items herein represents the number of passages in which a word appears. The procedure proceeds to execute box 1320, box 1320 find Sps of all passages, for the determining method of Sp, refer to FIG. 14. The following boxes 1322-1336 determine the passages of which the approximate cosine values are at the top r. The program uses heap to implement this functionality in the following procedure: Firstly the approximate cosine values of r passages of Number 1 to Number r passages is computed, and the minimal heap of these r passages is established on this basis. Minimal heap features that the value of root-node is less than its two leaf-nodes, and therefore the value of the root-node is the least.

After that it starts from Number r+1 passage to compare the approximate cosine degree of similarity of each remaining passage with that of the heap root-node. If the cosine degree of similarity of a passage is greater than the value of the root-node, this passage shall be ranked in the top r. Assume this passage is p. Then the passage of the heap root-node is deleted, and the degree of similarity of the passage p is put into the root-node. The cosine degree of similarity recently put into the heap root-node is not necessarily the least one within r passages in heap. Accordingly, the sequence of the heap is destructed, and a heap sequence needs to be reestablished. This process is repeatedly executed for the remaining passages, and finally the passages in the heap are r passages with top cosine degrees of similarity. Therefore, box 1322 determines the approximate cosine degree of similarity of r passages of Number 1 to Number r passages (Sp from Number 1 to Number r divided by the approximate value of Wp can yield approximate cosine degree of similarity), the meaning of r-value has been described in the first implementation method. Box 1324 establishes the minimal heap of r passages in terms of r approximate cosine values. After, starting from Number r+1 passage, boxes 1328-1336 are executed for remaining passages (box 1326). Box 1328 identifies whether all of passages have been fully processed, if yes, the flow goes to box 1338 (to FIG. 13B). If there are any passages remaining unprocessed, box 1330 works out the approximate cosine degree of similarity of an unprocessed passage and assume this passage is p. Then box 1332 identifies whether the cosine degree of similarity of p is greater than that of the minimal heap root-node. If not, the flow goes to box 1328; if yes, the flow goes to box 1334. Box 1334 replaces the passage of root-node with p, the join of p may likely damage the sequence of heap (the cosine degree of similarity of p is not necessarily the least in the heap), therefore box 1336 re-generates heap sequence and then the flow goes to box 1328. The following boxes 1338-1356 (as shown in FIG. 13B) are the passages ranking from high to low in terms of cosine values, along with the ranking of documents. This system also implements this functionality with heap as procedures described below. The previous minimal heap is processed to convert it to a maximum one (maximum heap refers to the heap of which the root-node value is more than the two leaf-node values) (box 1338), the root-node value of the maximum heap is the maximum value in the heap, successive exporting of passages of root-node corresponds to top-down ranking of passages in terms of cosine values. For the moment, cosine values in the heap are approximate cosine values, and the root-node is the maximum approximate cosine value. As known, the approximate Wp value is less than or equal to precise Wp, therefore, the approximate cosine value is greater than or equal to its corresponding precise cosine value (in Formula 1.1, it is divided by Wp). The passage with maximum approximate cosine value is not always with maximum exact value, and therefore it is necessary to find the precise cosine value of root-node passage. If a precise cosine value is the maximum value, it is certainly the maximum precise value of all passages in the heap. Since approximate cosine value is greater than or equal to its corresponding precise cosine value, if a precise cosine value is more than the approximate cosine value of one passage, it is certainly more than the precise cosine value of this passage. On this account if under sequence of a heap, root-node is a precise cosine value, this precise cosine value of root-node is certainly the maximum one in heap and the passage it corresponds to is ranked foremost in the heap, and therefore it can be taken out from the heap. Box 1342 identifies whether a certain number of documents (Max_Docs) have been in the document queue or whether all of passages in the heap have been processed. Max_Docs is the number of documents desired to be searched, for example, if 1000 documents are desired to be searched, then Max_Docs equals to 1000. If the conditions of box 1342 are satisfied, box 1358 outputs the documents searched, and the document search phase ends. Otherwise, box 1344 computes the precise cosine value of root-node passage. The precise cosine value is not always the maximum one, and therefore box 1346 re-establishes the heap sequence. On condition that the previous precise cosine value is the maximum, it will remain at the root-node. If it is not the maximum, the root-node is replaced by another value, which may be either the approximate cosine value or the precise cosine value. On the condition that it is the precise cosine value, based on the previously described reasons, it is definitely the maximum among all precise cosine values in the heap. In such a case its corresponding passage can be removed from this heap. Therefore box 1348 identifies whether the cosine value in heap's root-node is a precise cosine value or not. If not, the flow goes to box 1344; if yes, the flow goes to box 1350 to remove the passage of heap's root-node from the heap. Box 1352 re-establishes the heap's sequence. Passages are successively taken out from the heap, every time when a passage is taken out, box 1354 checks to see if the document containing this passage has been ranked (i.e., whether it has been put into document queue), if not yet, box 1356 adds the corresponding document to the document queue, and the flow goes to box 1342. If the passage-corresponding document has already been ranked (already in the document queue), indicating that there has been other passages in this document have been selected previously. Since the document is ranked in terms of its passage with topmost cosine value, this document is not necessarily to be put into document queue, the flow goes directly to box 1342. boxes 1342-1356 are repeated until Max_Docs documents have been contained in document queue or all passages in heap have been fully processed. Finally the documents of the queue are outputted.

FIG. 14 is the flow diagram for determination of Sp (for computation of Sp refer to Formula 1.4). Firstly box 1402 initializes Sps of all passages to 0, then box 1404 identifies whether words in query have been processed. If all the words have been processed, the flow goes to the end, if not, box 1406 takes a word t from query. Box 1408 consults the dictionary to get t's index information, including initial point of index, index length Len and index term number ft. Box 1410 allocates memory based on the index length Len of t. Box 1412 reads the index of t from hard disk into memory. Box 1414 initializes passage number p into 0. Box 1416 finds Wt, Wt=logₑ (1+N/ft), where N is the number of all of passages. Box 1418 identifies whether there are still any index terms in the index of t remaining unprocessed, i.e., identifies whether ft=0. If ft equals to 0, indicating all of index terms of t have already been processed, then the flow goes to box 1404. If not, box 1420 decodes the index of t, yielding an index term (Diff_p, num). Since Diff_p is the difference between passage numbers, the current passage's number p=p+diff_p (box 1422), Sp=Sp+(1+logₑnum)×Wt (box 1424), by this time an index term of t has been processed, therefore ft=ft−1 (box 1426), the flow goes to box 1418.

The present invention mainly relates to a method forming passages. An information retrieval system is developed to show an application of the method and the efficiency of the method. But the method is not limited to the field of information retrieval. It can be applied to other natural language processing problems such as automatically question-answering etc.

The descriptions and diagrams presented herein should be understood as a specific implementation method of the present invention rather than a restricted area. The implementation of this invention is variable within the range of its concept. For example, a Boolean Query can also be adopted at the passage level, although the ranked-query is used in this disclosure. Additionally, the system herein returns documents but can also be modified such that it returns corresponding passages.

What is claimed is:

1. A method for analyzing a document and determining passages included in said document, the method comprising:
If a document contains less than N paragraphs, processing whole said document as a passage;
If a document contains N or more than N paragraphs, merging each N consecutive paragraphs in said document to form a passage;
Wherein N is a number greater than 1;
Whereby if a document contains N or more than N paragraphs, then in said document, two passages that beginning position is the nearest have N−1 paragraphs to overlap, namely, there are N−1 paragraphs in said two passages to be identical.

2. The method of claim 1, further comprising:
If said document contains N or more than N paragraphs, merging the first N−1 consecutive paragraphs to form the first passage of said document, merging the last N−1 consecutive paragraphs to form the last passage of said document.

3. The method of claim 1, wherein a preferred value of said N is 5

4. The method of claim 2, wherein a preferred value of said N is 5

5. A method for forming index, the method comprising:
If a document contains less than N paragraphs, processing whole said document as a passage;
If a document contains N or more than N paragraphs, merging each N consecutive paragraphs of said document to form a passage.
Relating the passages formed above with words to form said index;
Wherein said N is a number greater than 1.

6. The method of claim 5, further comprising:
If a document contains N or more than N paragraphs,
Merging the first N−1 consecutive paragraphs of said document to form the first passage of said document, relating said first passage with words to form the index concerning said first passage, merging the last N−1 paragraphs of said document to form the last passage of said document, relating said last passage with words to form the index concerning said last passage.

7. The method of claim 5, wherein a preferred value of said N is 5.

8. The method of claim 6, wherein a preferred value of said N is 5.

9. An index on computer-readable medium, said index is formed by a process, said process comprising:
If a document contains less than N paragraphs, processing whole said document as a passage.
If a document contains N or more than N paragraphs, merging each N consecutive paragraphs in said document to form a passage
Relating the passages formed above with words to form said index.
Wherein N is a number greater than 1.

10. The index on computer-readable medium of claim 9, said index formed by said process, said process further comprising:
If a document contains N or more than N paragraphs, merging the first N−1 consecutive paragraphs of said document to form the first passage of said document, relating said first passage with words to form index concerning said first passage, merging the last N−1 consecutive paragraphs of said document to form the last passage of said document, relating said last passage with words to form the index concerning said last passage.

11. The index on computer-readable medium of claim 9, wherein a preferred value of said N is 5.

12. The index on computer-readable medium of claim 10, wherein a preferred value of said N is 5.

13. A computer-readable medium having program used to analyze a document and determine passages included in said document, said program comprising:
If a document contains less than N paragraphs, processing whole said document as a passage;
If a document contains N or more than N paragraphs, merging each N consecutive paragraphs of said document to form a passage;
Wherein said N is a number greater than 1;

14. The computer-readable medium of claim 13, wherein said program further comprising:
If a document contains N or more than N paragraphs, merging the first N−1 consecutive paragraphs of said document to form the first passage of said document, merging the last N−1 consecutive paragraphs to form the last passage of said document.

15. The computer-readable medium of claim 13, wherein the preferred value of said N is 5

16. The computer-readable medium of claim 14, wherein the preferred value of said N is 5.

17. A computer-readable medium having program for forming index, said program comprising:
If a document contains less than N paragraphs, processing said whole document as a passage, relating the passage formed with words to form said index;
If a document contains N or more than N paragraphs, merging each N consecutive paragraphs of said document to form a passage;
Relating the passages formed above with words to form said index;
Wherein said N is a number greater than 1;

18. The computer-readable medium of claim 17, wherein said program further comprising:
If a document contains N or more than N paragraphs, merging the first N−1 consecutive paragraphs of said document to form the first passage of said document, relating said first passage of said document with words to form the index concerning said first passage, merging the last N−1 consecutive paragraphs to form the last passage, relating said last passage of said document with words to form the index concerning said last passage.

19. The computer-readable medium of claim 17, wherein the preferred value of said N is 5.

20. The computer-readable medium of claim 18, wherein the preferred value of said N is 5.
